(19) United States
(12) Patent Application Publication
(10) Pub. No.: US 2009/0001308 A1
(43) Pub. Date: Jan. 1, 2009

(54) Valve to shaft assembly

(76) Inventors: Dominic N. Dalo, Rochester, NY (US); David C. Shuler, Rochester, NY (US); Frank A. Nicholas, W. Henrietta, NY (US); David A. Chinnici, Rochester, NY (US); Paul H. Williams, Rochester, NY (US); Edward A. Cary, Victor, NY (US)

Correspondence Address: DELPHI TECHNOLOGIES, INC., M/C 480-410-202, PO BOX 5052, TROY, MI, 48007, US

(21) Appl. No.: 11/821,974

(22) Filed: Jun. 26, 2007

(51) Int. Cl. F16K 1/22

(52) U.S. Cl. 251/308

(57) ABSTRACT

A valve to shaft assembly includes a butterfly-type valve, a pair of bushings receiving the valve and holding the valve in axial position within a housing, and a shaft engaging the valve and the bushings and rotating the bushings in the housing. The bushings include features to hold the valve in position in the bore prior to assembly of the valve and, furthermore, act as rotating bearing surfaces for the valve. The valve to shaft assembly process may be simplified, especially where multiple valves are assembled to a single common drive shaft, such as in a port face charge motion control valve. Furthermore, the valve to shaft assembly provides an axial degree of freedom between valve, drive shaft, and bore, which allows the valve to float on the axis of the drive shaft, to facilitate self centering of the valve in the valve housing.

### TECHNICAL FIELD

The present invention relates to internal combustion engines; more particularly, to engine air control valves; and most particularly, to a valve to shaft assembly without fasteners and a method for assembling a butterfly-type valve within a housing.

### BACKGROUND OF THE INVENTION

Butterfly-type valves having a rotatable valve plate fixed to a shaft are generally well known in the art of internal combustion engine design. Such butterfly-type valves have traditionally been used on throttle bodies and carburetors, more recently on throttle bodies of fuel injected engines, and are currently used inside intake manifolds with greater frequency. Butterfly-type valves are typically used to regulate airflow in order to create a desired combustion mixture within the engine. Butterfly-type valves may be used, for example, in electronic throttle control bodies, mechanical throttle bodies, diesel electronic throttle control body housings, or intake manifolds, and may be used as, for example, electronic throttle control valves, mechanical throttle body valves, diesel intake throttle body valves, or charge motion control valves.

Traditionally, throttle valves have been affixed to shafts by mechanical means, usually fasteners. Typically a flat is milled on the shaft, a valve having holes in it is positioned on the flat, and fasteners, such as screws, are used to secure the valve to the shaft. The screws may be staked to the shaft to keep them from coming off. Even though, a constant concern is the potential risk of a fastener loosing during vehicle operation. If a fastener was to come loose, the valve could dislodge form the desired position. This in turn may generate noise or may possibly cause the valve to bind with the bore and become inoperable. A loosened fastener may also become disengaged from the shaft and fall into the engine. An inoperable valve may lead to emission failures, an inoperable vehicle, unwanted acceleration, etc. Also, in the event of a fastener coming completely loose there is the danger of engine damage.

In the prior art, various approaches have been made to prevent fasteners fromloosening. These approaches include, for example, application of adhesives, replacing threaded fasteners with rivets, and upsetting the threads on the fastener to prevent rotation. All of these options add additional steps during the valve assembly adding to the assembly cost. Furthermore, these various approaches may not prevent a fastener from loosening with time during operation.

In further prior art, where multiple valves are assembled to a single common drive shaft, such as in a charge motion control valve, each of the intake runners may have a separate valve body, designed to split open or to include multiple parts, to receive valves and bearings or bushings manufactured as a single part or pre-assembled. Other prior art approaches include a multi-part bushing/bearing assembly that is inserted in the bores for receiving a drive shaft. During the assembly process, the drive shaft is fed through the bushing/bearing assembly and through sleeves integrated in the valve alternating until all valves are assembled to the common drive shaft.

What is needed in the art is a low cost solution for affixing a valve to a shaft without using mechanical means, such as fasteners, when the shaft is positioned within a housing, whether as a single valve assembly or as a multiple valve assembly as in a charge motion control valve. It would further be desirable to simplify the assembly process of butterfly-type valves in intake manifolds.

### SUMMARY OF THE INVENTION

Briefly described, a valve to shaft assembly in accordance with the invention includes a pair of bushings for each intake manifold runner that retain a butterfly-type valve and receive a shaft. Contrary to the prior art, where the valve is typically affixed to the shaft using mechanical means, such as fasteners, the bushings in accordance with the present invention enable assembly of the valve to the shaft without using fasteners. Furthermore, the valve to shaft assembly in accordance with the invention ensures that there are no loose valves on the drive shaft that could generate noise or become dislodged. Also, by pivoting valves on molded non-metal bushings, a quiet operation in the rotational and axial directions is achieved. In another aspect of the invention, the bushings include features to hold the valve in position in the bore prior to assembly of the valve and, furthermore, act as rotating bearing surfaces for the valve. Consequently, the valve to shaft assembly process may be simplified, especially where multiple valves are assembled to a single common drive shaft, such as in a charge motion control valve serving multiple intake runners. Although detailed description of the preferred embodiment herein will be directed to a charge motion control valve, it is understood that the invention is useful with throttle bodies, carburetors, or any other application where a butterfly-type valve is assembled in a housing.

In accordance with the present invention, variable airflow within an intake manifold runner tract for improved cold start emissions and fuel economy is accomplished by providing a notched, center pivot butterfly-type valve. By designing the valve, which may be stamped metal, to have an as thin as possible profile, low flow restrictions may be achieved when the valve is fully open. Furthermore, the valve to shaft assembly in accordance with the invention provides an axial degree of freedom between valve, drive shaft, and bore, which allows the valve to float on the axis of the drive shaft, to facilitate self centering of the valve in the valve housing, such as in a multiple valve intake manifold runner. This free floating design of the valve to shaft assembly provides that the manifold, in which multiple valves are installed, may be manufactured, for example, as a molded composite, a die-cast, or a sand-cast, whereas prior art manifolds need to be machined to maintain proper valve fit among a ganged set of multiple valves.

### BRIEF DESCRIPTION OF THE DRAWINGS

The present invention will now be described, by way of example, with reference to the accompanying drawings, in which:

FIG. 1 is an exploded isometric view of a charge motion control valve assembly;

FIG. 2 is a plan front view of a bushing; and

FIG. 3 is a cross-sectional view taken along line 3-3 in FIG. 2.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

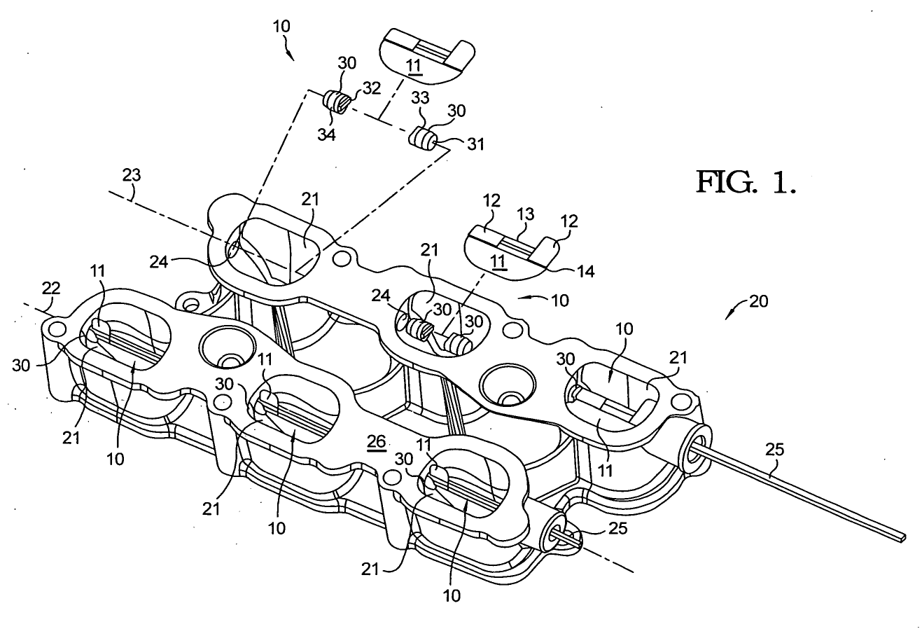

Referring now to the drawings, there is seen in FIG. 1 a preferred embodiment of the inventive valve to shaft assembly 10 incorporated into a charge motion control valve assembly 20 of a V6 internal combustion engine. It is understood that charge motion control valve assembly 20 is provided for purpose of description only and the invention is not limited to the particular charge motion control assembly 20 design shown in FIG. 1. Rather, the invention is applicable to any type of valve housing design and any application where a butterfly-type valve is assembled to a shaft within a housing, which could benefit from the advantages the present invention offers as further explained below.

Referring to FIG. 1, a charge motion control valve assembly 20 of a V6 internal combustion engine includes a manifold runner set 26. The manifold runner set 26 includes multiple runners 21. As shown in FIG. 1, three of the runners 21 are lined up longitudinally along an axis 22 and three of the runners 21 are lined up longitudinally along an axis 23, which is positioned parallel to axis 22. More or less runners 21 may be used and, furthermore, the runners 21 may be any type of valve housing in accordance with the invention. Each runner 21 includes two shaft bores 24 positioned opposite from each other and extending longitudinally along axis 22 or axis 23. Shaft bores 24 of multiple runners 21 are lined up in series along axis 22 or axis 23. Axis 22 and axis 23 are axes of rotation.

A valve to shaft assembly 10 includes butterfly-type valve 11, a pair of bushings 30, and a drive shaft 25. One valve to shaft assembly 10 is inserted into each of the runners 21. A single common drive shaft 25 is then fed through the multiple valve to shaft assemblies 10. The drive shaft 25 rotates the bushings 30 and the bushings 30 turn the valves 11.

Drive shaft 25 may be a single piece of un-machined metal stock that has a non-round cross-section, preferably a square or rectangular cross-section. Drive shaft 25 is a compliant member and, as a result, may be flexed due to a small cross-section relative to its length. By being a compliant member, assembly of the drive shaft 25 does not require the shaft bores 24 of the manifold 26 to be perfectly aligned. Hence, it is not necessary to precisely drill bores 24 to assure close-to-perfect alignment relative to axes 22 or 23. The drive shaft 25 engages the bushings 30 by its non-round cross section and may or may not directly engage valves 11. Multiple valves 11 may be assembled to a single common shaft 25 as more fully described below. In the case of a single runner 21 or single valve housing, bores 24 receive a drive shaft 25 that may not be shared with an adjacent runner.

Still referring to FIG. 1, the butterfly-type valve 11 may be a notched, center pivot butterfly valve. In a preferred embodiment, the valve 11 is a thin metal valve having an as thin as possible cross-section to minimize flow restrictions when valve 11 is fully open. The metal valve 11 may be, for example, manufactured during a stamping process by a progressive die. Valve 11 includes features that hold the valve 11 in place in an axial direction along axis 22 or 23 and that prevent the valve 11 from sliding underneath the shaft 25 and from falling out after assembly. Thus, the valve 11 becomes trapped on the shaft 25 without using fasteners.

Alternating bands of metal 12 and 13 may be pushed in opposite directions during the valve forming process. For example, bands 12 may be pushed up in vertical direction while the middle band 13 may be pushed down. The pushed up bands 12 form a step 14. The middle band 13 may further be shaped to match the cross-section of the shaft 25. Together the alternating bands of metal 12 and 13 form a multi-sided non-round pattern as viewed along axes 22, 23 to surround the shaft to kept the valves from slipping past the bushings and falling out of the bores after assembly. In one aspect of the invention, the bands of metal 12 and 13 may form a multi-sided non-round pattern that matches the cross-section of shaft 25. The multi-sided pattern is formed to be in alignment with the axis of rotation, such as axis 22 or 23. The bands 12 and 13 are formed such that when the valve is viewed along the axis of rotation, such as axis 22 or 23, the shaped bands 12 and 13 will appear as a fully closed geometric shape. As a variation, one of the bands, such as middle band 13 may have an open band pattern that is left unshaped until after insertion of the shaft 25. The band 13 may be crimped onto the shaft 25 as a final assembly step. Alternatively, middle band 13 may be left in the open band pattern if not needed for gripping valve 11. It may further be possible to push the middle band 13 in the same direction as the bands 12 to form step 14 in order to keep the valve from slipping past the bushings and falling out of the bore after assembly. Also, the bands 12 and 13 may be a single band that is shaped to form step 14. Step 14 extends in axial direction and is positioned adjacent to shaft 25 once installed.

It may further be possible to use valves 11 made from composite or other materials. In an alternative embodiment, valve 11 may be a molded plastic valve.

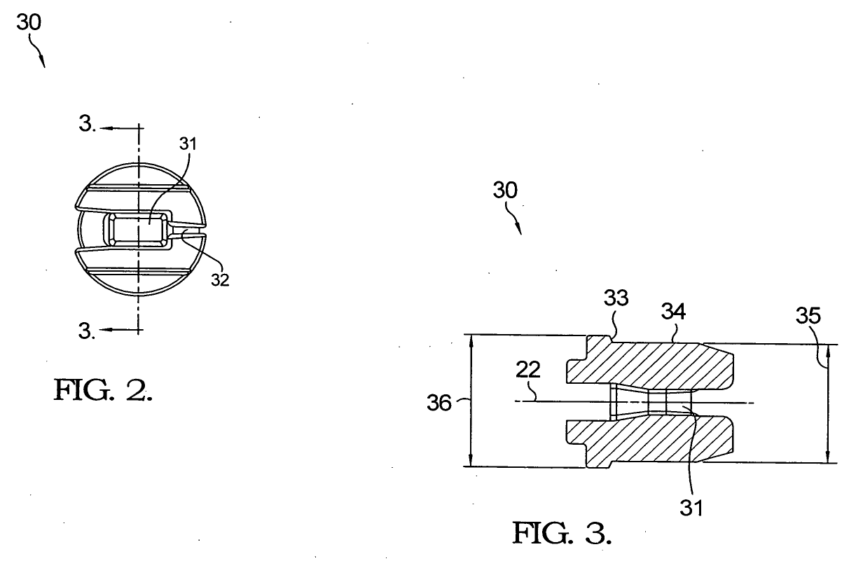

Referring to FIGS. 2 and 3, bushing 30 has a cylindrical shape that extends along axis 22 (or 23), which is the axis of rotation, and an outer diameter 35 selected to fit closely into shaft bore 24. Bushing 30 includes a center aperture 31 that receives the drive shaft 25 and, therefore, has the same non-round cross-section as the shaft 25, for example, a rectangular cross-section as shown. Center aperture 31 may be designed to be closely conforming to the cross-section of the shaft 25. By matching the cross-section of the center aperture 31 and of the shaft 25, the bushing 30 may be rotated by the shaft 25.

Bushing 30 further includes at least one distinctive element, such as slot 32 shown in FIG. 2, that receives, in a close fitting manner, valve 11, that firmly grips valve 11, and that secures valve 11 in axial position within runner 21. Bushing 30 may further include a pickup spring or any other depressible member to complement the purpose of bushing 30, in accordance with the invention, at the root of the slot 32 that is depressed when the valve is assembled in a pair of bushings 30 and that then applies pressure to the inserted valve 11 ensuring a tight fit between valve 11 and the bushings 30.

Bushing 30 further includes a shoulder 33 that has a larger diameter 36 than the shaft bore 24 and that holds bushing 30 in an axial position in shaft bore 24 prior to assembly of valve 11 and shaft 25. The diameter 36 of shoulder 33 is larger than the outer diameter 35.

Bushing 30 also includes a bearing surface 34 at the outer circumference and, therefore, functions as a rotating shaft bearing within shaft bore 24. Consequently, the material for the bushing is selected for lubricity and wear characteristics, as well as in consideration of the material the bushing 30 is rotating against. Bushings 30 are preferably formed of a plastic material, such as commercial grade nylon, for example, nylon PA66GF, through injection molding. A polymer is the preferred material due to high resistance to engine heat, chemical resistance, and noise canceling properties. Other materials that complement the purpose of bushings 30, in accordance with the invention, may be used; for example, oil impregnated bronze, aluminum, and brass. Bushing 30 may also be, for example, a powder-metal part, a die-cast, a sinter part, or a machined part if desired.

Referring again to FIG. 1, during the assembly process of the charge motion control valve 20, a pair of bushings 30 is placed into the shaft bores 24 of a first runner 21. The shoulder 33 of the bushings 30 ensures that the bushings 30 are positioned correctly in the bores 24 preventing the bushings 30 from slipping too far or even completely inside the bores 24. After slots 32 are aligned to receive the valve, valve 11 is inserted into slots 32 of a pair of bushings 30. The bushings 30 retain valve 11 within runner 21 and, in turn, the valve retains the bushings within bore 24. These steps are repeated for each runner 21. Then the drive shaft 25 is inserted through the center aperture 31 of the bushings and along the step 14 of the valve 11. The drive shaft 25 positively engages the bushings 30. If a multi-sided non-round pattern that matches the cross-section of the shaft 25 was formed with the metal bands 12 and 13, then the shaft 25 is inserted through that formed pattern as well. If the middle band 13 is left in open band position, it may by crimped around the shaft 25 after inserting the shaft 25 or the band 13 may remain in open band position. Since the valve 11 is tightly gripped by a pair of bushings 30 and secured in place by the bushings in the axial direction, step 14 incorporated in the valve 11 may be sufficient to keep valve 11 from sliding underneath the shaft 25 and from falling out. Thus, valve 11 is secured to shaft 25 without fasteners and multiple valves 11 may be assembled to a single common valve shaft 25 in a relatively simple assembly process that requires only low cost tooling.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A valve to shaft assembly, comprising:
a butterfly-type valve;
a pair of bushings receiving said valve and holding said valve in axial position within a housing; and
a shaft engaging said bushings, said shaft rotating said bushings in said housing.

2. The valve to shaft assembly of claim 1, wherein said housing includes a pair of shaft bores positioned at opposite sides along an axis, and wherein said shaft bores receive said bushings.

3. The valve to shaft assembly of claim 1, wherein said bushings include a shoulder having a larger diameter than said shaft bores.

4. The valve to shaft assembly of claim 1, wherein said shaft has a non-round cross-section.

5. The valve to shaft assembly of claim 1, wherein said bushings include a center aperture that receives said shaft, and wherein said center aperture has a non-round cross-section that is identical with a cross-section of said shaft.

6. The valve to shaft assembly of claim 1, wherein said bushings include at least one distinctive element that grips said valve and secures said valve in position.

7. The valve to shaft assembly of claim 1, wherein said valve includes a step that extends in an axial direction and that is positioned adjacent to said shaft.

8. The valve to shaft assembly of claim 1, wherein said valve is a stamped metal valve and includes alternating metal bands pushed in opposite vertical directions.

9. The valve to shaft assembly of claim 8, wherein said metal bands form a multi-sided non-round pattern that has the same cross-section as said shaft, wherein said pattern aligns with the axis of rotation.

10. The valve to shaft assembly of claim 1, further comprising:
at least one additional valve, at least one additional pair of bushings receiving said additional valve and holding said additional valve in axial position within an additional housing;
wherein said shaft is a single common shaft that engages said additional pair of bushings.

11. A bushing for assembling a butterfly-type valve within a housing, comprising:
a cylindrical shape extending along the axis of rotation;
a distinctive element that receives said valve and secures said valve in position within said housing;
a shoulder positioned at said outer circumference of said cylindrical shape; and
a bearing surface positioned at said outer circumference of said cylindrical shape.

12. The bushing of claim 11, further including a center aperture having a non-round cross-section and extending along said axis of rotation, and wherein said center aperture closely conforms to a cross-section of a shaft received within said housing.

13. The bushing of claim 12, wherein said center aperture receives said shaft, and wherein said shaft rotates said bushing.

14. The bushing of claim 11, wherein said cylindrical shape has an outer diameter that is selected to fit into shaft bores of said housing.

15. The bushing of claim 14, wherein said shoulder has a larger diameter than the shaft bores of said housing.

16. The bushing of claim 11, wherein said distinctive element is a slot designed as a valve press.

17. The bushing of claim 11, wherein said bushing is an injection molded plastic part.

18. A method for assembling a butterfly-type valve within a housing, comprising the steps of:
placing a pair of bushings into shaft bores of said housing;
inserting said valve into said pair of bushings; and
retaining said valve with said bushings within said housing.

19. The method of claim 18, further including the steps of:
engaging said bushings with a drive shaft;
rotating said bushings with said drive shaft; and thereby
rotating said valve with said bushings.

20. The method of claim 18, further including the step of rotating a plurality of said pairs of bushings with said drive shaft.
